(19) United States
(12) Patent Application Publication
(10) Pub. No.: US 2016/0232934 A1
(43) Pub. Date: Aug. 11, 2016

(54) OPTICAL DISK DEVICE, LIBRARY SYSTEM AND DATA RECORDING METHOD

(71) Applicant: Hitachi-LG Data Storage, Inc., Tokyo (JP)

(72) Inventor: Kenji AKAHOSHI, Tokyo (JP)

(21) Appl. No.: 15/002,781

(22) Filed: Jan. 21, 2016

(30) Foreign Application Priority Data
Feb. 9, 2015 (JP) 2015-023461

(51) Int. Cl. G11B 7/0045

(52) U.S. Cl. CPC G11B 7/00458

(57) ABSTRACT

An optical disk device records recording data transmitted from a host device onto an optical disk. Then, as a process for checking the recorded data, the optical disk device reproduces the data from the optical disk to perform a Verify process in a recording quality determination unit, while transmitting the reproduced data to the host device. The host device performs a Compare process to compare the reproduced data transmitted from the optical disk device with the recording data transmitted to the optical disk device. At least if it is determined to be poor quality as a result of the Verify process by the recording quality determination unit or if it is determined that the data do not match as a result of the Compare process by the host device, the corresponding data is alternately recorded in an alternate area of the optical disk.

### CLAIM OF PRIORITY

The present application claims priority from Japanese patent application serial No. JP 2015-023461, filed on Feb. 9, 2015, the content of which is hereby incorporated by reference into this application.

### BACKGROUND OF THE INVENTION

(1) Field of the Invention

The present invention relates to an optical disk device for recording data onto an optical disk, a library system, and a data recording method.

(2) Description of the Related Art

In an optical disk device for recording data onto an optical disk and in a library system on which the optical disk device is mounted, a Verify process and a Compare process are performed to increase the reliability of recorded data. The Verify process is a process for checking the recording quality of the recorded data. The Compare process is a process for checking whether or not the data recorded on the optical disk can be read without any error. These processes are performed as part of a recording process, both of which reproduce the recorded data from the optical disk to perform their respective check processes.

Japanese Unexamined Patent Application Publication No. 2014-146403 discloses a configuration that is intended to reduce the time required for the recording process including Verify process and Compare process, in which a recording/reproduction device (optical disk device) stores the quality information at the time of reproduction into a recording quality storage unit and, at the same time, transmits the reproduced data to a host controller (host device). The host controller performs a Compare process by comparing the transmitted data with the data at the time of recording, or performs a Verify process by obtaining the quality information of the reproduction area from the recording/reproduction device at predetermined intervals and checking the recording quality.

### SUMMARY OF THE INVENTION

According to the configuration disclosed in Japanese Unexamined Patent Application Publication No. 2014-146403, the reproduction of the same recording area is performed only once, so that the time required for Verify process and Compare process can be reduced to about half of the time when the reproduction of the same recording area is performed twice.

On the other hand, if bad recording (NG) is identified in Verify process and Compare process, the following process has been performed. First, if any data is identified as NG (below the required quality) as a result of the Verify process, an alternate process is performed to record again the corresponding recorded data into an alternate area on the disk in order to increase the reliability of the data. However, if NG (data mismatch) is present as a result the Compare process, the corresponding disk medium has been discarded without performing the alternate process (if it is a recordable medium). Although the Verify process allows the optical disk device (drive) to determine by itself and easily perform the alternate process immediately after NG is identified, the Compare process needs to transmit the reproduced data to the host device side to check the matching of the data. For this reason, it has been difficult to use the alternate process that the optical disk device performs by itself in the past.

As described above, since the Compare process does not perform the alternate process, once a disk is identified as Compare NG, this disk is to be discarded, and this is a problem that should be addressed in terms of saving media resources and the merits of users. Japanese Unexamined Patent Application Publication No. 2014-146403 does not specifically describe the process of the disk that is identified as NG in Verify process and Compare process.

The present invention aims at reducing the number of disk media that are identified as NG as a result of the Compare process and will be discarded.

According to an aspect of the present invention, there is provided an optical disk device connected to a host device to perform recording and reproduction of data. The optical disk device includes: a recording/reproduction unit for performing processing of data to be recoded and reproduced onto an optical disk; a recording quality determination unit for performing a Verify process to determine the quality of the recorded data; and an interface for transmitting/receiving data and commands between the optical disk device and the host device. After the recording data is transmitted from the host device and is recorded onto the optical disk, as a process of checking the recorded data: the optical disk device performs a Verify process in the recording quality determination unit by reproducing the data from the optical disk, while transmitting the data reproduced from the optical disk to the host device; a Compare process is performed in the host device to compare the reproduced data transmitted from the optical disk device with the recording data transmitted to the optical disk device; and at least either if it is determined to be poor quality as a result of the Verify process by the recording quality determination unit or if it is determined that the data do not match as a result of the Compare process by the host device, the corresponding data is alternately recorded in an alternate area of the optical disk.

Further, according to another aspect of the present invention, there is provided a library system connected to a host device to perform recording and reproduction of data onto a plurality of optical disks. The library system includes: a disk storage unit for storing a plurality of optical disks; a plurality of optical disk devices, each of which is mounted with the optical disk to recode and reproduce data; a recording quality determination unit for performing a Verify process to determine the quality of the data recoded on the optical disk; and a library controller for transmitting/receiving data and commands between the library system and the host device and controlling the optical disk devices. After the recording data is transmitted from the host device and is recorded onto the optical disk, as a process of checking the recorded data: the optical disk device performs a Verify process in the recording quality determination unit by reproducing the data from the optical disk, while transmitting the data reproduced from the optical disk to the host device; a Compare process is performed in the host device to compare the reproduced data transmitted from the optical disk device with the recording data transmitted to the optical disk device; and at least either if it is determined to be poor quality as a result of the Verify process by the recording quality determination unit or if it is determined that the data do not match as a result of the Compare process by the host device, the corresponding data is alternately recorded in an alternate area.

Further, according to still another aspect of the present invention, there is provided a data recording method for recording data onto an optical disk. The data recording method includes the steps of: recording data to be recorded onto the optical disk; reproducing the data from the optical disk to perform a Verify process to determine the quality of the recoded data; performing a Compare process for comparing the data reproduced from the optical disk with the recording data; and at least either if it is determined to be poor quality as a result of the Verify process or if it is determined that the data do not match as a result of the Compare process, alternately recording the corresponding data in an alternate area of the optical disk.

According to the present invention, it is possible to reduce the number of disk media that are identified as NG as a result of the Compare process and will be discarded. As a result, it is possible to save media resources and to increase the merits of users.

### BRIEF DESCRIPTION OF THE DRAWINGS

These and other features, objects and advantages of the present invention will become more apparent from the following description when taken in conjunction with the accompanying drawings wherein:

FIG. 1 is a configuration diagram showing an embodiment of an optical disk device 1 according to the present invention (first embodiment);

FIG. 2 is a diagram showing the flow of the data in the data recording process;

FIGS. 3A and 3B are diagrams showing the alternate process;

FIG. 4 is a flow chart of the entire recording process; and

FIG. 5 is a configuration diagram showing an embodiment of a library system 3 according to the present invention (second embodiment).

### DETAILED DESCRIPTION OF THE EMBODIMENT

Hereinafter, embodiments of the present invention will be described in separate sections, an optical disk device and a library system.

### First Embodiment

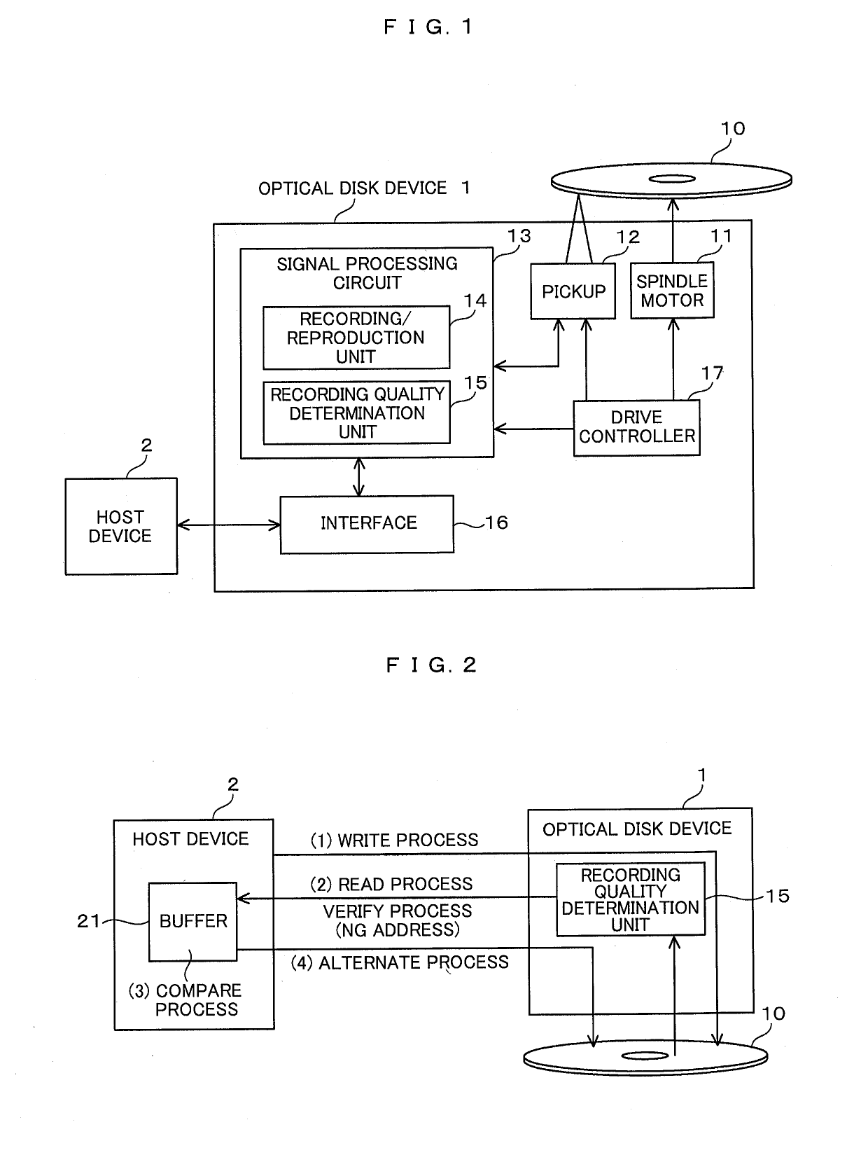

A data recording process in an optical disk device will be described in a first embodiment. FIG. 1 is a configuration diagram showing an embodiment of an optical disk device 1 according to the present invention. The optical disk device 1 is connected to an upper host device 2 to perform recording and reproduction of data by following the instructions of the host device 2. The recording operation includes alternate recording in the alternate process. Further, the reproduction operation includes reproduction to check the recoded data.

An optical disk 10 is rotated by a spindle motor 11 to record and reproduce data by a pick up 12. A signal processing circuit 13 includes a recording/reproduction unit 14 and a recording quality determination unit 15. The recording/reproduction unit 14 performs various processes (coding, decoding, error processing, and the like) on the recorded/reproduced data. The recording quality determination unit 15 determines the quality of the reproduced data that is obtained at the time of Verify. The signal processing circuit 13 is connected to the external host device 2 through an interface 16 to transmit and receive the recorded/reproduced data and commands between it and the host device 2. A drive controller 17 controls the operation of the respective units of the optical disk device 1.

In the configuration of this embodiment, the recording quality determination unit 15 is provided within the optical disk device 1 in order to determine the quality of the reproduced data at the time of Verify. The data quality determination value (threshold) used should be a common data quality determination value taking into account the whole system of both the optical disk device 1 and the host device 2. In other words, even if a plurality of optical disk devices 1 are connected to the host device 2, the same data quality determination value is used in the whole system. In general, the determination of the quality is performed based on the parameters obtained in the reproduction of the optical disk 10. For this reason, performing the determination of the quality in the optical disk device 1 is effective and popular. Of course, the host device 2 can also perform the data quality determination as long as the host device 2 can obtain the parameters necessary for the data quality determination.

FIG. 2 is a diagram showing the flow of the data in the data recording process. In the data recording process of this embodiment, a Verify process, a Compare process, and an alternate process are performed in order to check the recorded data, in addition to data recording. These processes are performed by transmitting and receiving data between the host device 2 and the optical disk device 1. The host device 2 includes a buffer 21 to temporarily store the recording data. The optical disk device includes the recording quality determination unit 15 to perform Verify determination.

(1) The host device 2 instructs the optical disk device 1 to perform recording. Then, the host device 2 transmits recording data to the optical disk 10. The optical disk device 1 performs signal processing on the transmitted data by the recording/reproduction unit 14, and records the processed data onto the optical disk 10 (hereinafter referred to as write process).

(2) The host device 2 terminates the transmission of the recording data. When the write process in the optical disk device 1 is completed, the host device 2 instructs the optical disk device 1 to perform a Verify process and a Compare process. The optical disk device 1 performs reproduction of the recorded area (hereinafter referred to as read process). Then, the optical disk device 1 transmits the reproduced data to the host device 2. At the same time, the recording quality determination unit 15 of the optical disk device 1 determines the data quality (for example, the error rate) during the reproduction process in the recording/reproduction unit 14, by comparing it with the threshold (Verify process). Then, if it is determined to be poor quality (Verify NG), the recording quality determination unit 15 transmits the information of the NG data (NG address information) to the host device 2.

(3) The host device 2 compares the reproduced data received from the optical disk device 1 with the recording data recoded in the buffer 21 to check whether the data match or not (Compare process). If the data do not match, it is determined to be Compare NG.

(4) When Verify NG or Compare NG is present, the host device 2 instructs the optical disk device 1 to perform an alternate process on the data (alternate data) of the area that is determined to be NG. In response to this instruction, the optical disk device 1 recodes the alternate data into the alternate area of the optical disk 10.

Then, returning to the step (2), the host device 2 instructs again the optical disk device 1 to perform the Verify process and the Compare process to check whether the alternately recorded data has been correctly recorded, and repeats the operation described above. In this way, any disk that is determined to be Compare NG again after the alternate process will be discarded.

As described above, according to the present embodiment, even when not only Verify NG but also Compare NG is present, it is possible to save the disk by performing the alternate process, and to reduce the number of disks that are eventually determined to be Compare NG. Further, the read process for the Verify process and the Compare process needs to be performed only once, so that it is possible to reduce the time required to perform the check process.

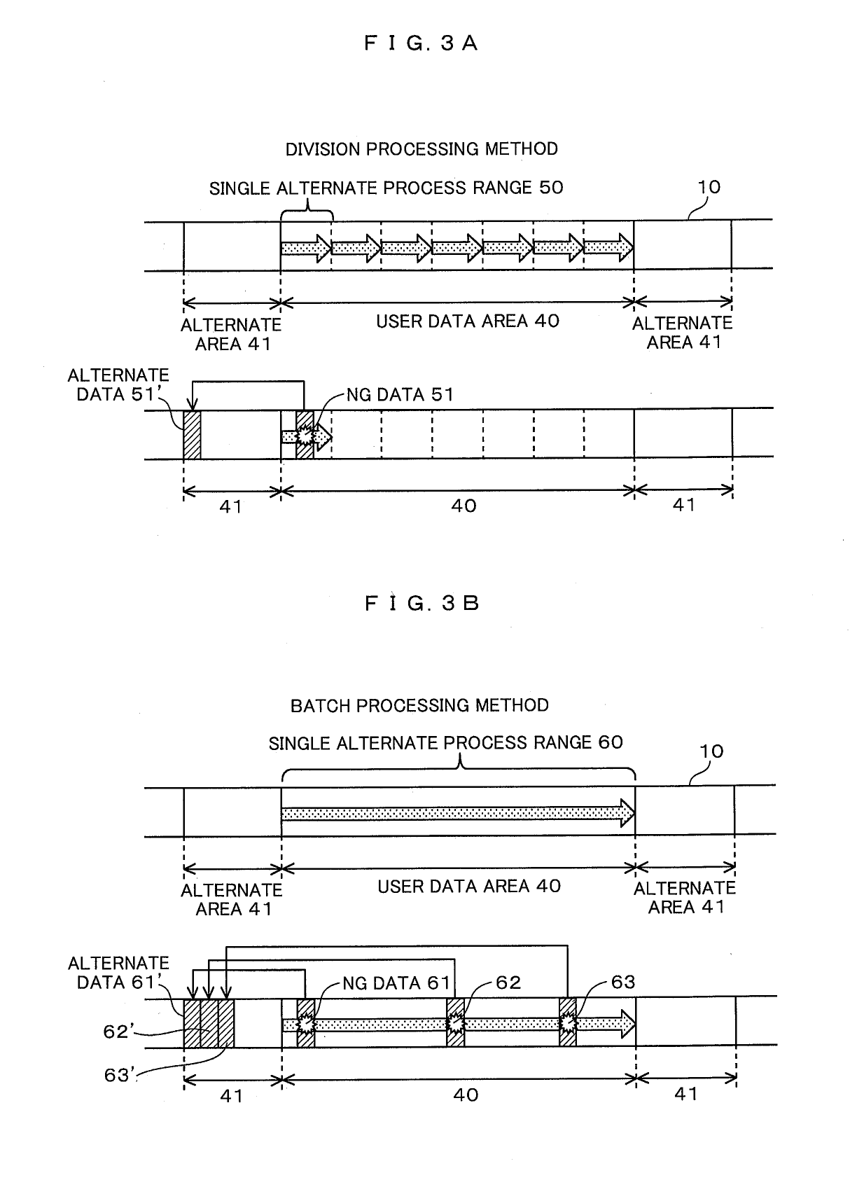

FIGS. 3A and 3B are diagrams showing the alternate process. An alternate area 41 is provided on the optical disk 10 in advance, in addition to a user data area 40. For example, the alternate area 41 is provided on either the inner peripheral side or the outer peripheral side, or on both sides. The size of the alternate area 41 is prepared based on the expected amount of data of the alternate process. When the data recoding in the user area 40 is completed, the Verify process and the Compare process are performed by reproducing the data recorded in the user area 40. The alternate process is performed when there is data that is determined to be NG in either process. Based on the address of the data that is determined to be NG, the alternate process reads the corresponding data from the buffer 21 and records the particular data as alternate data into the alternate area 41. The processing unit of the alternate process is selected from the following methods.

FIG. 3A shows a division processing method. This method is a method of dividing the user data area 40 into alternate process ranges 50 to perform the alternate process for each alternate process range 50. If data that is determined to be NG is present in each alternate process range 50, the division processing method refers to the buffer 21 and records the corresponding data as alternate data 51′ into the alternate area 41. Then, the division processing method performs the alternate process on the next alternate process range 50. This method is effective when the capacity of the buffer 21 in which the recording data is temporarily stored for the alternate process is small. In this case, the data size for the write process and the alternate process is set according to the buffer capacity. However, this method has a disadvantage that the number of times of the seek operation increases and the transfer rate is reduced, because the write process and the read process (Verify) are repeated with a small size.

FIG. 3B shows a batch processing method. This method is a method of performing the alternate process on the data recorded in the user data area 40 as an alternate process range 60 in batch. If data 61, 62, and 63 that are determined to be NG are present in the alternate process range 60, the batch processing method refers to the buffer and records their corresponding data as data 61′, 62′, and 63′ in batch into the alternate area 41. This method is effective when the capacity of the buffer 21 in which the recording data is temporarily stored for the alternate process is large. By performing the write process and the read process (Verify) all at once, there is no need to repeat the detailed seek operation and, as a result, the transfer rate is increased.

In the present embodiment, the recording data is stored in the buffer 21 in the host device 2. It is easy to store, for example, the amount of data for one disk in the buffer 21. Thus, the batch processing method of FIG. 3B can be used, and allows the write process, the read process, and the alternate process to be performed sequentially on the entire surface of the disk in batch. As a result, the efficiency of the entire recording process can be increased.

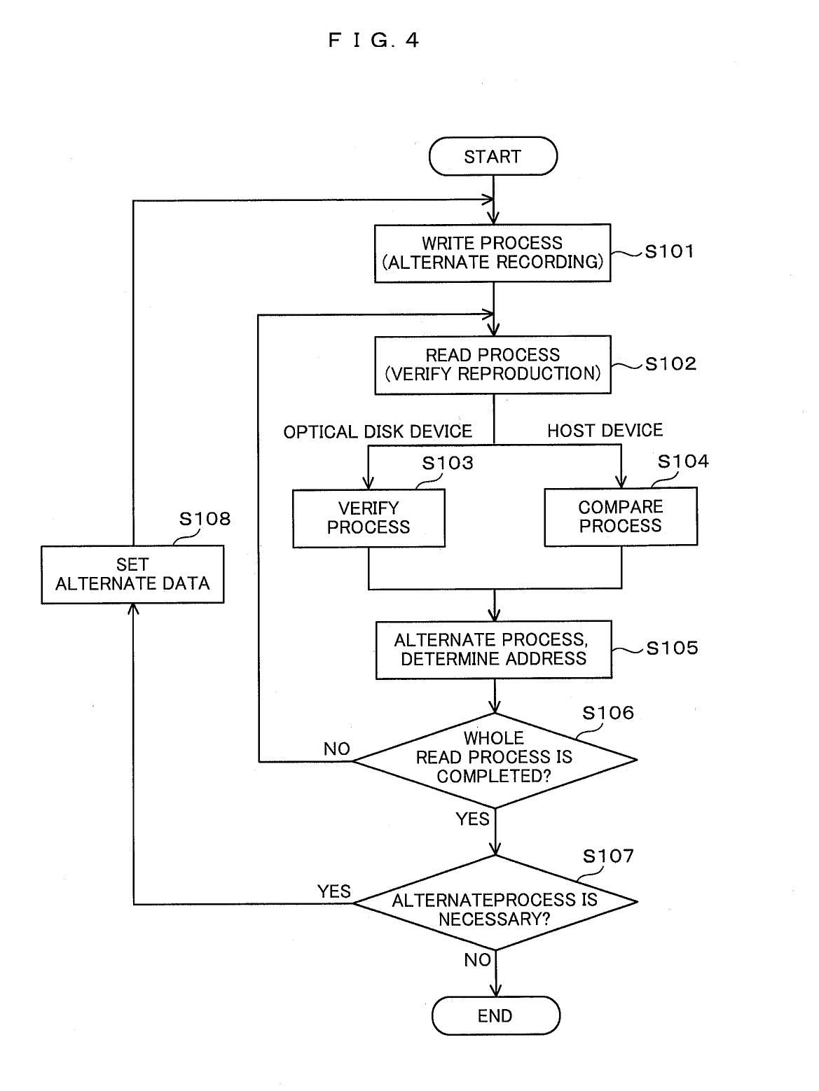

FIG. 4 is a flow chart of the whole recording process. The following flow is performed by instructions of the host device 2.

In S101, the host device 2 instructs the optical disk device 1 to perform the write process to record data into the user data area 40 of the optical disk 10. Note that this step also corresponds to the case of alternate recording that follows S108. However, the alternate data is recorded into the alternate area 41 in the alternate recording.

In S102, the host device 2 instructs the optical disk device 1 to perform the read process to reproduce the data recorded in the user data area (the reproduction at this time is also referred to as the Verify reproduction). A single read process can be applied to all data on which the write process has been performed, or part of it. After that, the step is branched into S103 (Verify process) and S104 (Compare process). In S104, the reproduced data is transmitted to the host device 2 from the optical disk device 1.

In the Verify process of S103, the data quality (for example, the error rate) is compared with the threshold by the recording quality determination unit 15 of the optical disk device 1. When the data quality is less than the threshold, it is determined to be Verify NG, and the address information is transmitted to the host device 2. Note that the threshold for determination can be previously stored in the recording quality determination unit 15, or can be set by a command from the host device 2.

In the Compare process of S104, the host device 2 compares the reproduced data received from the optical disk device 1 with the recording data stored in the buffer 21. If the data do not match, it is determined to be Compare NG.

In S105, if any data that is determined to be Verify NG or Compare NG is present, the host device 2 identifies the data as the target of the alternate process and determines its address. Note that in the case of Verify NG, the address information received from the optical disk device 1 can be used. In S106, the host device 2 determines whether the read process (Verify process, Compare process) is completed for all the data. If there is any unprocessed data, the host device 2 returns to S102 and repeats the process described above.

In S107, the host device 2 determines whether or not the alternate process is necessary. In other words, if any data that is determined to be Verify NG or Compare NG is present, the host device 2 determines that the alternate process is necessary and proceeds to S108. In S108, the host device 2 sets the alternate data by referring to the buffer based on the address of the data identified as the target of the alternate process.

Then, returning to S101 described above, the host device 2 instructs the optical disk device 1 to perform the write process (alternate recording) on the alternate data. At this time, the host device 2 issues a command of the write process with the same address as the NG address. In response to this command, the optical disk device 1 records the alternate data into the alternate area of the optical disk 10.

After that, the host device 2 performs the Verify process and the Compare process in S102 to S107 on the alternately recorded data. If any NG data is present, the host device 2 further repeats the alternate process. In this way, the host device 2 performs the alternate process until there is no NG data, or a predetermined number of times, and ends the process.

In the flow described above, the host device 2 can perform the alternate process in batch as shown in FIG. 3B by only receiving the address information that is necessary for the alternate recording, from the optical disk device 1.

Note that the following can be used as a variation of the process described above. When the data is determined to be NG as a result of the Verify process in S103, the above process transmits the address information of the NG data from the optical disk device 1 to the host device 2. However, it is also possible to transmit the determination flag (NG flag) instead of the address information of the NG data. When the reproduced data is transmitted to the host device 2 from the optical disk device 1, the NG flag is added to the end of the data. Then, the host device 2 receiving such reproduced data can determine which address is Verify NG because the received data is to respond to the command issued by the host device 2. In this way, it is possible to reduce the amount of data to be transmitted.

### Second Embodiment

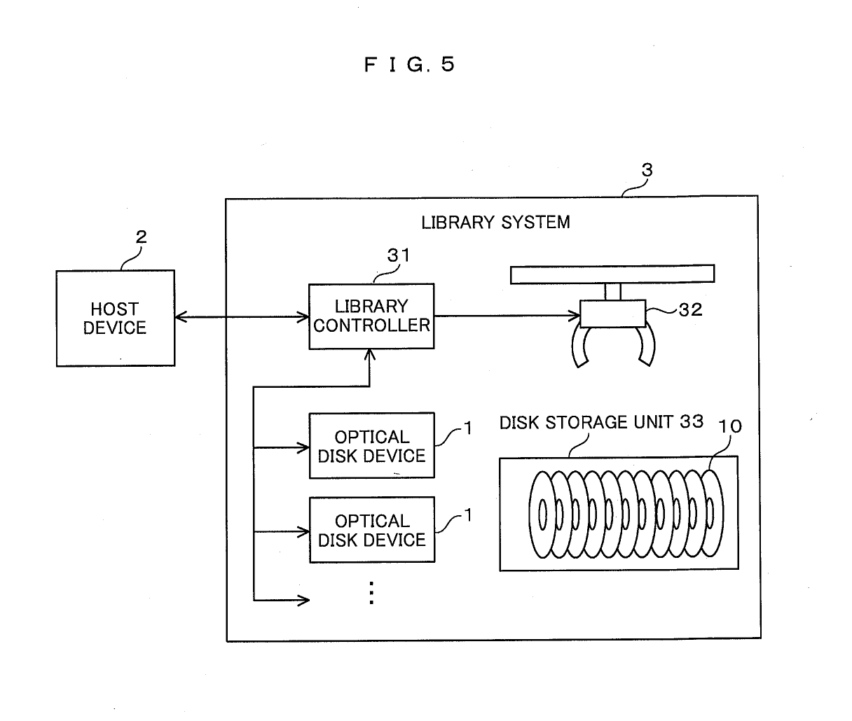

In a second embodiment, the data recording process in the library system will be described. FIG. 5 is a configuration diagram showing an embodiment of the library system 3 according to the present embodiment. The library system 3 includes one or a plurality of optical disk devices 1. The library system 3 is connected to the host device 2 to record and reproduce data by following the instructions of the host device 2. The host device 2 controls the library system 3 through communication with a library controller 31 included in the library system 3.

A large number of optical disks 10 are stored in a disk storage unit 33. Upon data recording/reproduction, the optical disk 10 is taken out from the disk storage unit 33 by a disk feed unit 32. Then, the optical disk 10 is attached to the optical disk device 1 to perform data recording/reproduction. When the recording/reproduction is completed, the optical disk 10 is returned to the disk storage unit 32 by the disk feed unit 33. The operation of the optical disk device 1 is controlled by the library controller 31 to perform data recording to the optical disk 10 or reproduction.

Also in the second embodiment, the recording process, the Verify process, the Compare process, and the alternate process are performed by transmitting and receiving data between the host device 2 and each of the optical disk devices 1 through the library controller 31. The details are the same as those described with reference to FIGS. 2 to 4 in the first embodiment. Thus, even when not only Verify NG but also Compare NG is present in a disk, it is possible to save the disk by performing the alternate process and to reduce the number of disks that are eventually determined to be Compare NG.

In the first and second embodiments described above, the recording quality determination unit 15 for the Verify determination is provided within the optical disk device 1. However, the present invention is not limited to this configuration. In other words, it is possible to configure such that the recording quality determination unit is provided in the host device. In this case, the optical disk device 1 transmits the recording quality information (for example, error information) that is necessary for the Verify determination, so that the Verify determination is performed in the host device 2.

It is also possible, in the second embodiment, to configure such that the recording quality determination unit is provided in the library controller 31 included in the library system 3. In this case, the optical disk device 1 transmits the recording quality information that is necessary for the Verify determination, to the library controller 31. Then, the library controller 31 performs the Verify determination and transmits the result (NG address, and the like) to the host device 2.

While we have shown and described several embodiments in accordance with out invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An optical disk device connected to a host device to perform recording/reproduction of data onto an optical disk, the optical disk device comprising:
a recording/reproduction unit for performing processing of data to be recoded and reproduced onto the optical disk;
a recording quality determination unit for performing a Verify process to determine the quality of the recorded data; and
an interface for transmitting/receiving data and commands between the optical disk device and the host device,
wherein, after the recording data is transmitted from the host device and is recorded onto the optical disk, as a process of checking the recorded data:
the optical disk device performs a Verify process in the recording quality determination unit by reproducing the data from the optical disk, while transmitting the data reproduced from the optical disk to the host device;
a Compare process is performed in the host device to compare the reproduced data transmitted from the optical disk device with the recording data transmitted to the optical disk device; and
at least either if it is determined to be poor quality as a result of the Verify process by the recording quality determination unit or if it is determined that the data do not match as a result of the Compare process by the host device, the corresponding data is alternately recorded in an alternate area of the optical disk.

2. The optical disk device according to claim 1, wherein if it is determined to be poor quality as a result of the Verify process by the recording quality unit, the optical disk device transmits the determination result to the host device, as the address information of the corresponding data or as a determination flag to be added to the reproduced data, and
wherein the host device identifies the alternate data to be alternately recorded based on the address information of the bad data received from the optical disk device, or based on its determination flag.

3. The optical disk device according to claim 1,
wherein the alternate recording based on the Verify process and the Compare process processes the data recorded on the optical disk in batch, without dividing it into pieces.

4. The optical disk device according to claim 1,
wherein upon execution of the alternate recording, the optical disk device performs the alternate recording based on the Verify process and the Compare process with respect to the data alternately recorded on the optical disk.

5. A library system connected to a host device to perform recording/reproduction of data onto a plurality of optical disks, the library system comprising:
a disk storage unit for storing the optical disks;
a plurality of optical disk devices, each of which is mounted with the optical disk to record/reproduce data;
a recording quality determination unit for performing a Verify process to determine the quality of the data recorded on the optical disk; and
a library controller for transmitting/receiving data and commands between the library system and the host device and for controlling the optical disk devices,
wherein, after the recording data is transmitted from the host device and is recorded onto the optical disk, as a process of checking the recorded data:
the optical disk device performs a Verify process in the recording quality determination unit by reproducing the data from the optical disk, while transmitting the data reproduced from the optical disk to the host device;
a Compare process is performed in the host device to compare the reproduced data transmitted from the optical disk device with the recording data transmitted to the optical disk; and
at least either if it is determined to be poor quality as a result of the Verify process by the recording quality determination unit or if it is determined that the data do not match as a result of the Compare process by the host device, the corresponding data is alternately recorded in an alternate area of the optical disk.

6. A data recording method for recording data on an optical disk, comprising the steps of:
recording data to be recorded onto the optical disk;
reproducing data from the optical disk to perform a Verify process to determine the quality of the recorded data;
performing a Compare process to compare the data reproduced from the optical disk with the recording data; and
at least either if it is determined to be poor quality as a result of the Verify process or if it is determined that the data do not match as a result of the Compare result, alternately recording the corresponding data in an alternate area of the optical disk.

7. The data recording method according to claim 6,
wherein the recording data is transmitted from the host device,
wherein the Compare process is performed in the host device by transmitting the reproduced data from the optical disk to the host device, and
wherein the alternate data to be alternately recorded is identified by the host device.
